(19) United States
(12) Patent Application Publication
(10) Pub. No.: US 2016/0189254 A1
(43) Pub. Date: Jun. 30, 2016

(54) DEVICE WITH "APPROVAL" INPUT

(71) Applicants: Timothy J. HALFMANN, Northfield, IL (US); TLM HOLDINGS, LLC, Northfield, IL (US)

(72) Inventor: TIMOTHY J. HALFMANN, Northfield, IL (US)

(21) Appl. No.: 14/913,653

(22) PCT Filed: Dec. 12, 2013
(86) PCT No.: PCT/US13/74738

§ 371 Date: Feb. 22, 2016

Related U.S. Application Data
(60) Provisional application No. 61/736,735, filed on Dec. 13, 2012.
(60) Provisional application No. 61/790,288, filed on Mar. 15, 2013.

(51) Int. Cl. G06Q 30/02; G06F 3/16; G06K 9/00; G06F 3/14; H04N 5/225

(52) U.S. Cl. CPC G06Q 30/0282; G06F 3/1431; H04N 5/225; G06K 9/00362; G06F 3/16

(57) ABSTRACT

The display may include a support for release-ably supporting a display device in communication with a surface. The display device may include a product announcement holder for displaying a product announcement. An input may be in communication with an input/output circuit and may be operable by a user to indicate a user approval. The approavls may be stored and analyzed. Finally, the display may include a counter display.

### CROSS-REFERENCE TO RELATED APPLICATION

This application claims priority to and incorporates by reference U.S. provisional application No. 61/736,735 filed on Dec. 13, 2012, and U.S. provisional patent application No. 61/790,288 filed on Mar. 15, 2013.

### BACKGROUND

Stores are filled with many products. Many of the products appear similar. Determining which products are desirable and which products are not desirable to a particular user is difficult to do in the confines of a retail store. Mobile phones may be able to obtain consumer review information from a remote web site but the data is often buried inside other unwanted information. In addition, using a mobile phone inside a store is a challenge as signal strength is often weak and the time required to obtain useful information can be excessive.

### SUMMARY

A display is disclosed. The display may include a support for supporting a display device in communication with a surface. The display device may include a product announcement holder for displaying a product announcement. The display device may be a simple illustration or a digital display device. A power source may be included which may be a battery, a solar cell, output from a transformer or any other power source. A processor may be in communication with the power source as is an input/output circuit. An input may be in communication with the input/output circuit and may be operable by a user to indicate a user rating or approval. A timing circuit may control the number of inputs that are displayed on the display in a given period of time as acceptable inputs. The display may gather and store data on user preferences which may be further analyzed. Finally, the display may include a counting or rating display.

### DESCRIPTION OF THE DRAWINGS

FIG. 1 is an illustration of a display;

FIG. 2 is an illustration of a display with a counter;

FIG. 3 is an illustration of a display with a rating;

FIG. 4 is an illustration of a display in communication with a shelf in a store;

FIG. 5 is an illustration of a display in a tabletop bracket in a store;

FIG. 6 is an illustration of a display with a counter in a tabletop bracket in a store;

FIG. 7 is an illustration of a display with a counter, a microphone, an image sensor, a speaker and a coupon dispenser;

FIG. 8 is an illustration of a method of collecting like data;

FIG. 9 is an illustration of a mobile computing device, a server type computer device and a communication device;

FIG. 10 is an illustration of a portable computing device;

FIG. 11 is an illustration of a server type computing device;

FIG. 12 is an illustration of an attachment support embodiment and orientation;

FIGS. 13a-13f are illustrations of some embodiments of the device;

FIG. 14a-d are illustrations of possible modular embodiments of the display;

FIG. 15 is an exploded rear view of one embodiment of the display;

FIG. 16 is an exploded front view of one embodiment of the display;

FIG. 17 is an exploded angled view of one embodiment of the display;

FIG. 18 is a view of one embodiment of the display; and

FIG. 19 is a view of one embodiment of the display with an announcement.

### SPECIFICATION

This application claims priority to and incorporates by reference U.S. provisional application No. 61/736,735 filed on Dec. 13, 2012, and U.S. provisional patent No. 61/790,288 filed on Mar. 15, 2013.

In accordance with the provisions of the patent statutes and jurisprudence, exemplary configurations described herein are considered to represent a preferred embodiment of the invention. However, it should be noted that the invention can be practiced otherwise than as specifically illustrated and described without departing from its spirit or scope.

At a high level, a display, as part of a computing system, may provide the ability to input approvals, likes or ratings for a product at a point of presence for a consumer, such as at a retailer. As a result, a user may make better decisions on buying products. In addition, the display 200 may collect data which may be used for market research and to understand consumer thoughts. The data may be collected in a variety of ways, from physical inputs and ratings directly from users to indirectly received inputs in the form of video and sound data. The data may be stored locally or remotely and the analysis of the data may occur in batches or in real time.

The display 200 may be useful as a point of presence in a variety of environments. In some embodiments, the display 200 may be useful in a retail environment where it may be useful to attract customers and collect data on their views on products. In addition, the display 200 may be useful in an even broader environment where feedback from users may be useful. As an example, a restaurant may value a rating on its service. Similarly, a car repair location may value user feedback and extra attention that the display 200 may bring. Virtually any business or person that values feedback could find the display 200 useful.

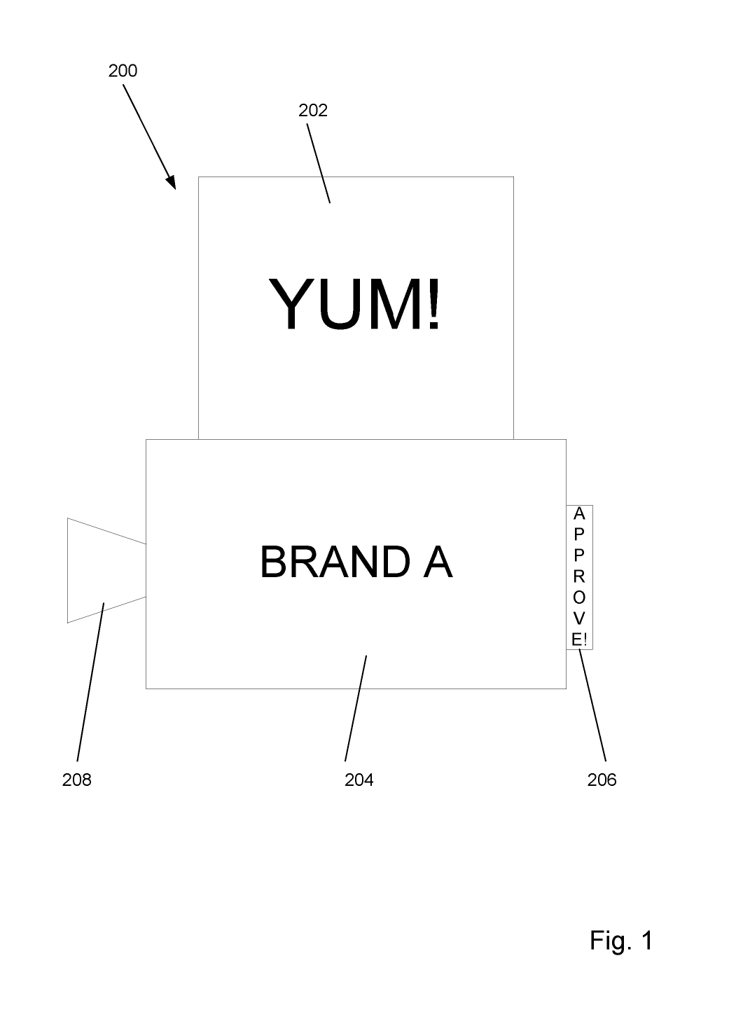

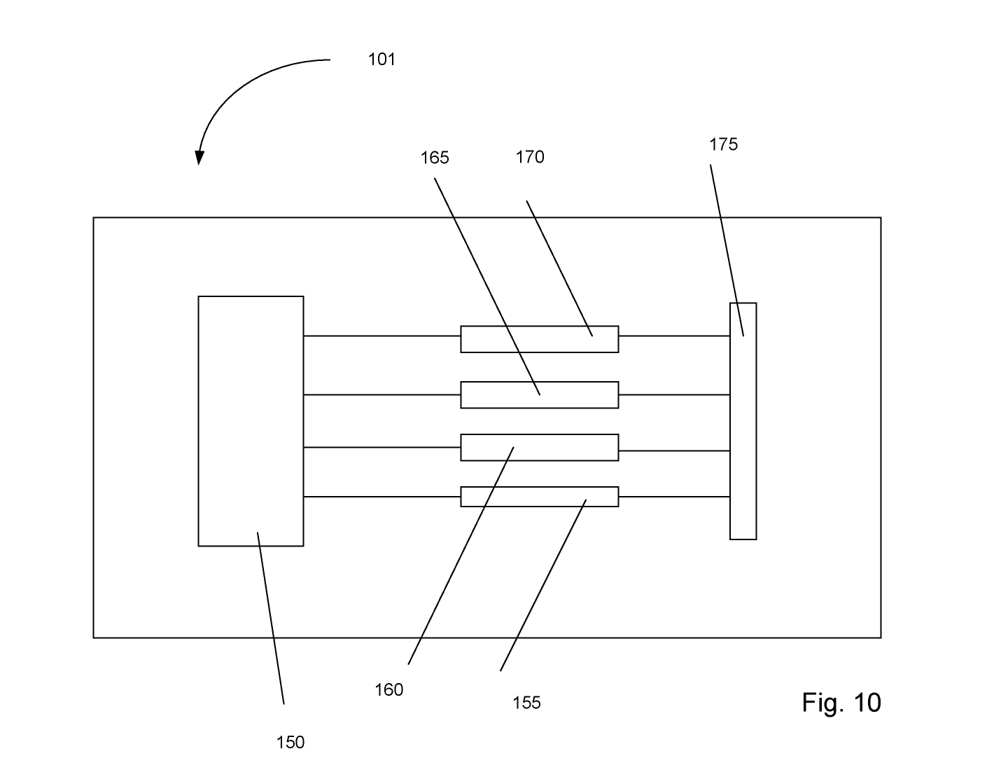

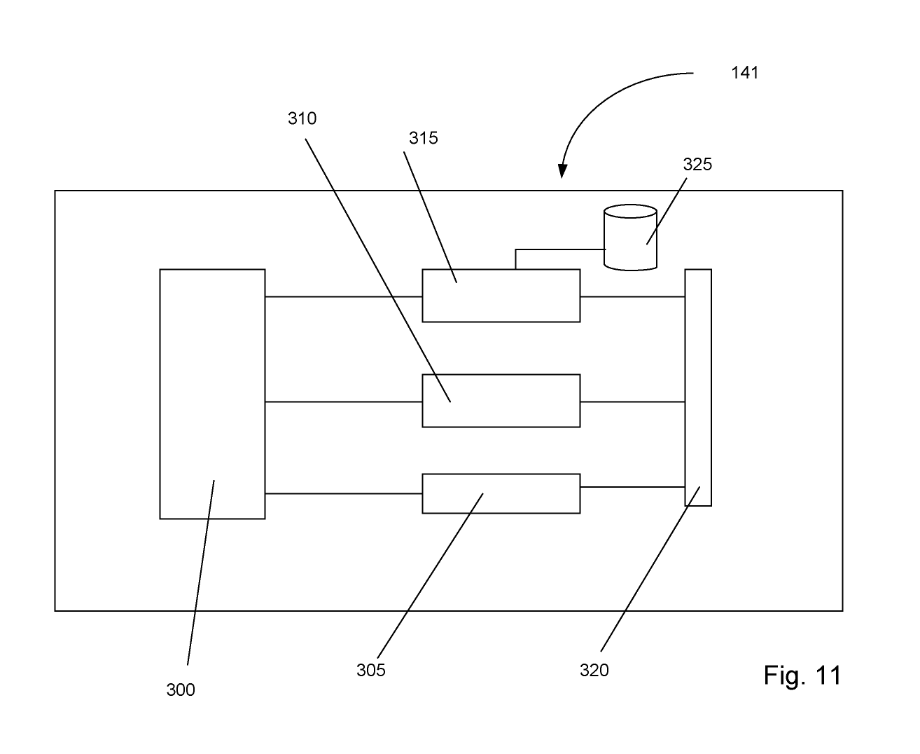

FIG. 1 illustrates a sample display 200. At a high level, the display 200 may have a product announcement 202, an enclosure 204 that may have an input 206 such as a “approval button” or a ratings button and a support 208 that supports the display 200 in an attractive and secure manner. The display 200 may include or be in communication with a processor 150, a memory 165 and an input/output circuit 175 such as those illustrated in FIGS. 10 and 11 and the processor 150 may be physically configured according to computer executable instructions to count the number of times the input 206 is actuated in an acceptable amount of time, display ratings data or to display approval indication data determined according to one or more algorithms.

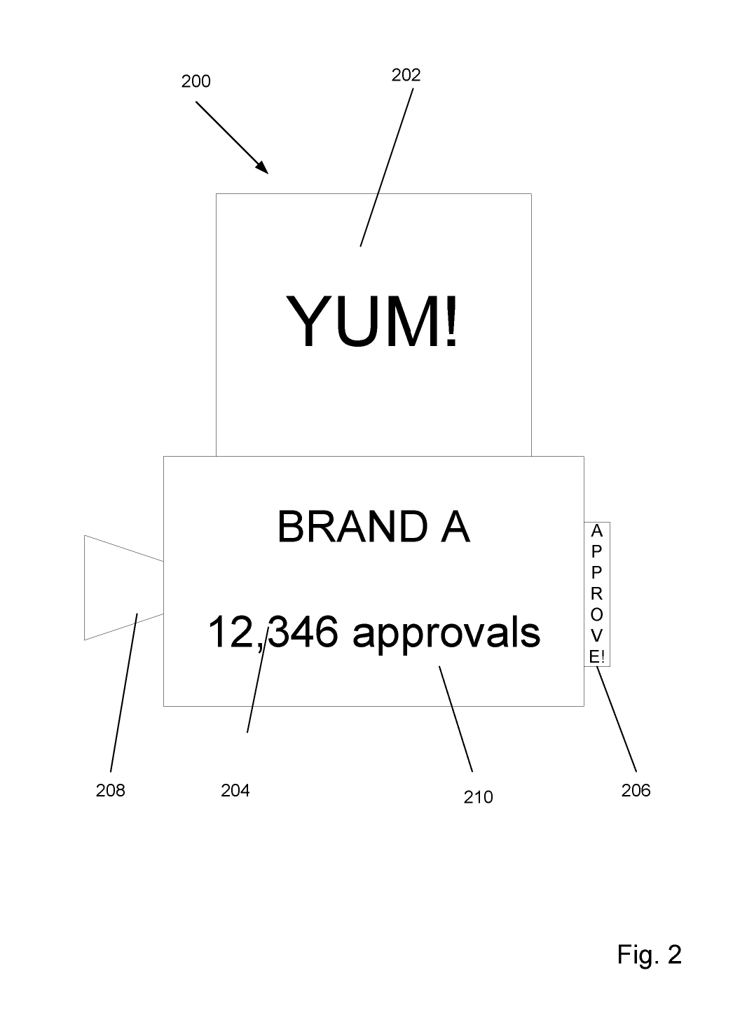

A user may actuate the input 206 to indicate they approve of the product on the product announcement 202 and one or more counters 210 (FIG. 2) may display the number of “approvals” or “likes” or if a rating is possible, one or more of many possible forms of the rating may be displayed. The counter 210 may take a variety of forms and may be actuated in a variety of ways. In some embodiments, the counter 210 may be a mechanical counter. In other embodiments, the counter 210 may be an electronic display such as an LCD display which may be black and white or color that is in communication with a processor as will be further explained. In yet another embodiment, the counter 210 may be a touch screen display device that has the capability to display a variety of colors, images, movies, etc. In yet another embodiment, the counter 210 may be in communication to an additional display such as a portable computing device 101 like a smart phone of a user or to an electronic display screen that is positioned near the device 200. In yet an additional embodiment, the various embodiments of the counter 210 may be used alone or in any combination. As a result, users may quickly see that a product is or is not liked or a level of approval which may influence a purchase decision. In addition, there may be a first electronic screen that acts as the counter 210 and a second electronic screen that displays additional information about the product such as price, novel features. etc.

As an example and not a limitation, an “approval” or “like” may be thought of as an approval, acceptance or a positive review. The word or sound of “like” is not necessary or the only way to indicate approval. The positive review may be in a variety of forms such as “I dig it”, “Cool”, a thumbs up symbol, a smile, four stars, etc. The word “like” is not necessary but is easily understandable for the purposes of this patent. Certainly, there is no desire to limit the claims or the disclosure to the word or symbol for “Like.” Further, a positive rating may also qualify as a like or as approval.

Referring to FIG. 1, the display 200 may have a variety of shapes. In some embodiments, the display 200 is shaped to be eye catching such as a star or be shaped as a stop sign. In other embodiments, the display 200 may be shaped in a manner that it may be mounted right side up and upside down. In some embodiments, the display 200 may be shaped in a manner to not interfere with the process of restocking shelves and allowing carts in a retail environment to pass without interference. For example, while a large display 200 may garner desired attention, it may interfere with carts in the aisle, hi some embodiments, the display 200 may be round to stand out from the linear arrangement of most stores. In some embodiments, there may be multiple displays 200. The multiple displays 200 may be for a single product or for a plurality of products such as when there is a comparison of products.

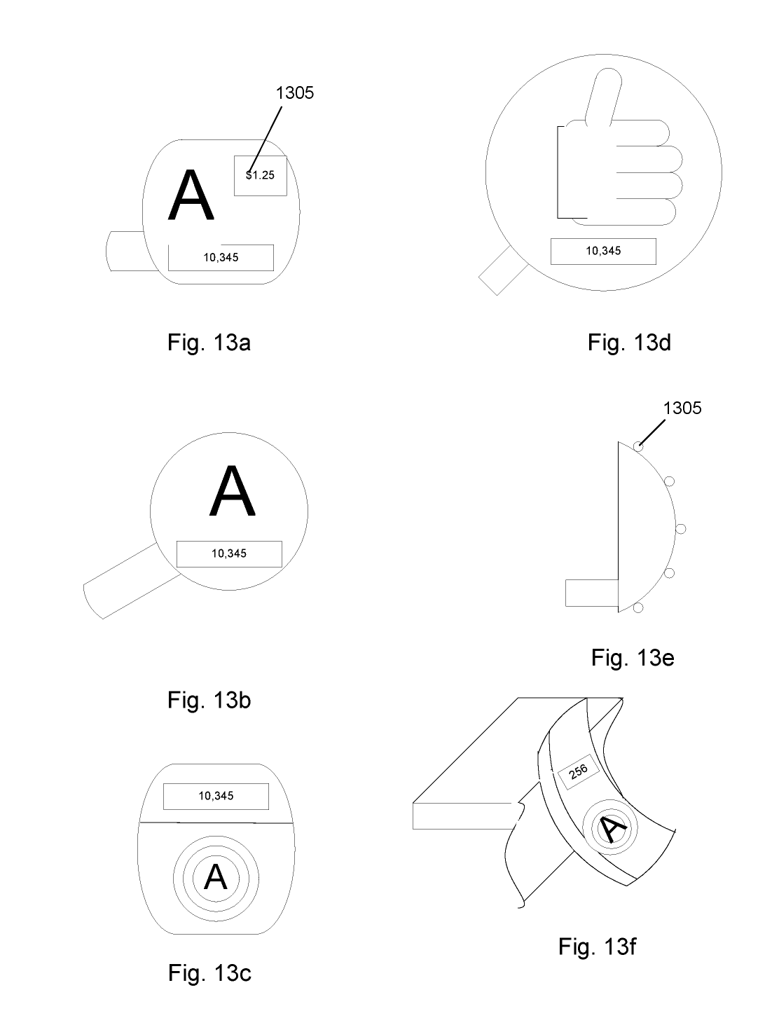

Referring briefly to FIGS. 13a-f, some possible implementations are illustrated. In some embodiments, the display 200 may have active features on more than one side, such as counters 210 and inputs 206 on opposite sides. In other embodiments such as in FIG. 13f, there may be a single counter 210 and a single input 206. In some embodiments, the display 200 is a stark white to stand out from the many bright colors in a store. In other embodiments, a variety of colors may be used as may be appropriate for the environment and the product.

The display 200 may be created from a variety of materials so long as the material is sufficiently durable to withstand the repeated use, light enough to be supported without extreme support measures being required and is appropriate for the environment. For example, the display 200 could be made from lead but lead is unnecessarily heavy and could be toxic if it rubbed off on the hands of users. In contrast, a plastic that is light, durable, eye catching and sturdy may be appropriate.

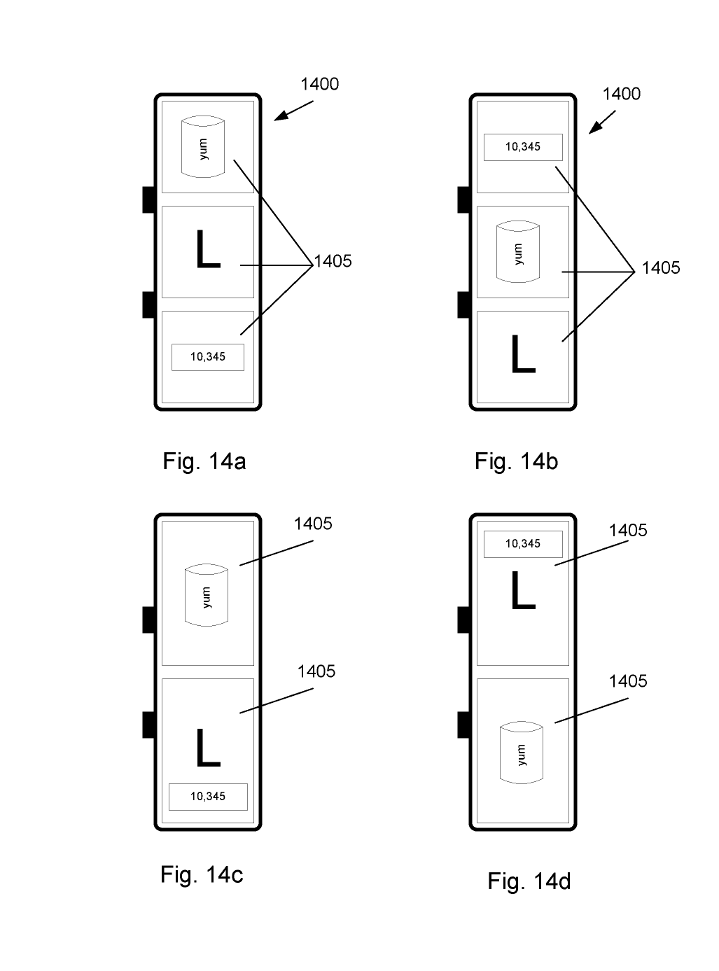

In some embodiments, the display 200 may be made up of one or more modular pieces. Referring briefly to FIG. 14, in one embodiment, there may be a frame 1400 in which the different modules 1405 lock into place. In another embodiment, the modules 1405 may not need a frame 1400 but may lock into each other. As illustrated in FIGS. 14a-14d, the modules 1405 may be arranged in a variety of orders. In some embodiments, there may be two modules 1405 and in other embodiments, there may be three or more modules 1405. The modules 1405 may connect together in a variety of known secure manners such as twist-to-lock, snap fit, bolts, clips, etc. In such an embodiment, changes may be easily made to the display 200 without having to completely remove the display 200.

In yet additional embodiments, a user may use a portable computing device 101 as part of the display 200. As will be explained in reference to FIG. 10, the portable computing device 101 may have a variety of manners of communicating with another computing device in the retail environment. The display 200 may have communication capabilities which interface with the portable computing device 101. In other embodiments, if the counter 210 has sophisticated capabilities, the display 200 may operate as a display that displays information communicated from another computing device 141 or 101. In some embodiments, the display 102 on the portable computing device 101 may mimic what is displayed on the counter 210 of the display 200.

In another embodiment, the portable computing device 101 may add additional features and illustrations to what is displayed on the counter 210 of the display 200 which may provide a more interactive experience for a user. For example, if the counter 210 is a simple black and white LCD directed toward displaying digits, the display 102 of the computing device 101 may display additional details communicated about the product such as nutritional information, advertisements available, other flavors of the product, other sizes available, etc. Similarly, the display 200 may operate as a source of digital data that may be available to portable computing devices 101 such as distributing applications, allowing users to access web pages related to the product, etc.

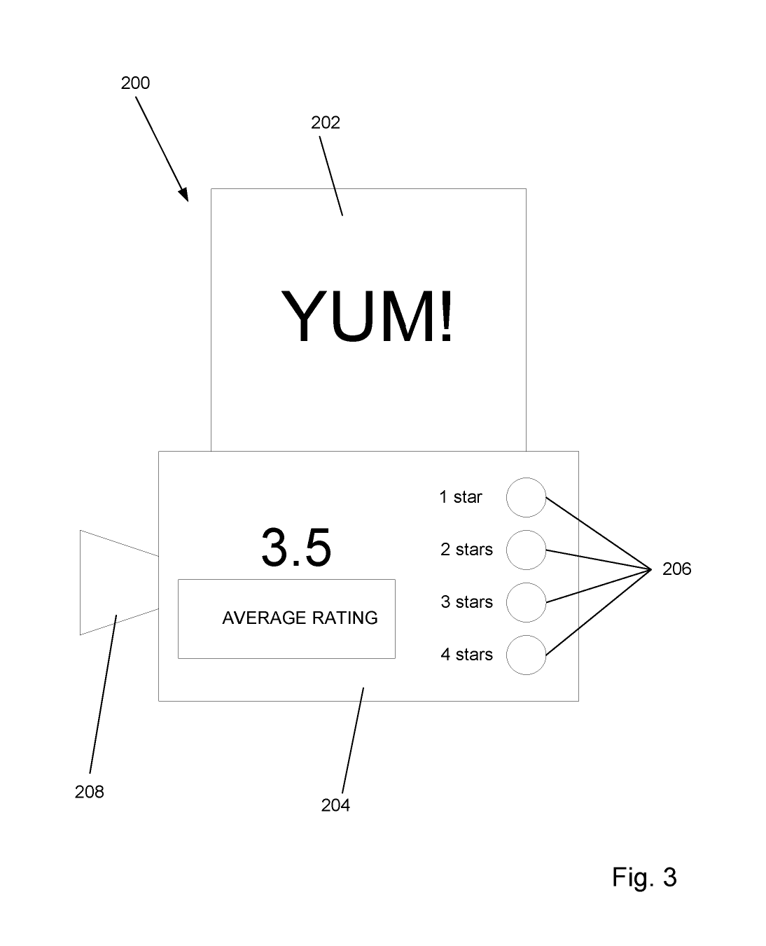

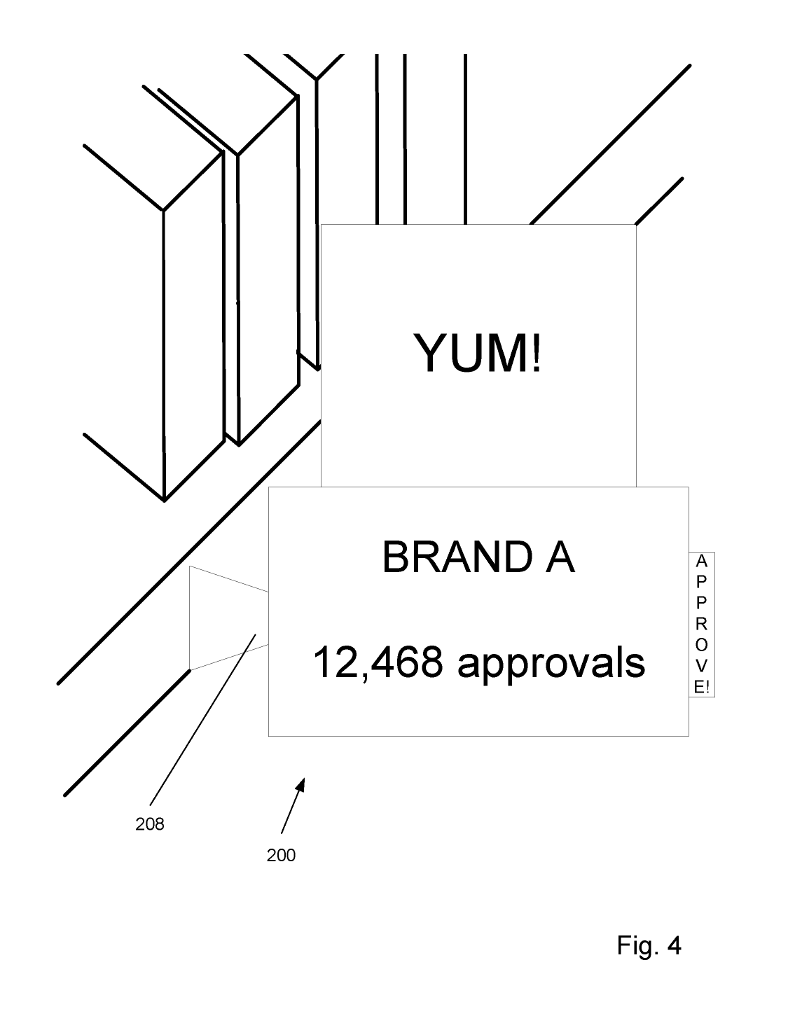

Referring again to FIG. 1, the support 208 for the display 200 may take on a variety of forms depending on the environment in which the display 200 is used. In some embodiments, the display 200 may be attached directly to a shelf in a retail environment, such as a grocery store. The support may release-ably lock into place such as illustrated in FIGS. 3 and 4. In this embodiment, the display 200 may be in a relatively close location to the product being advertised.

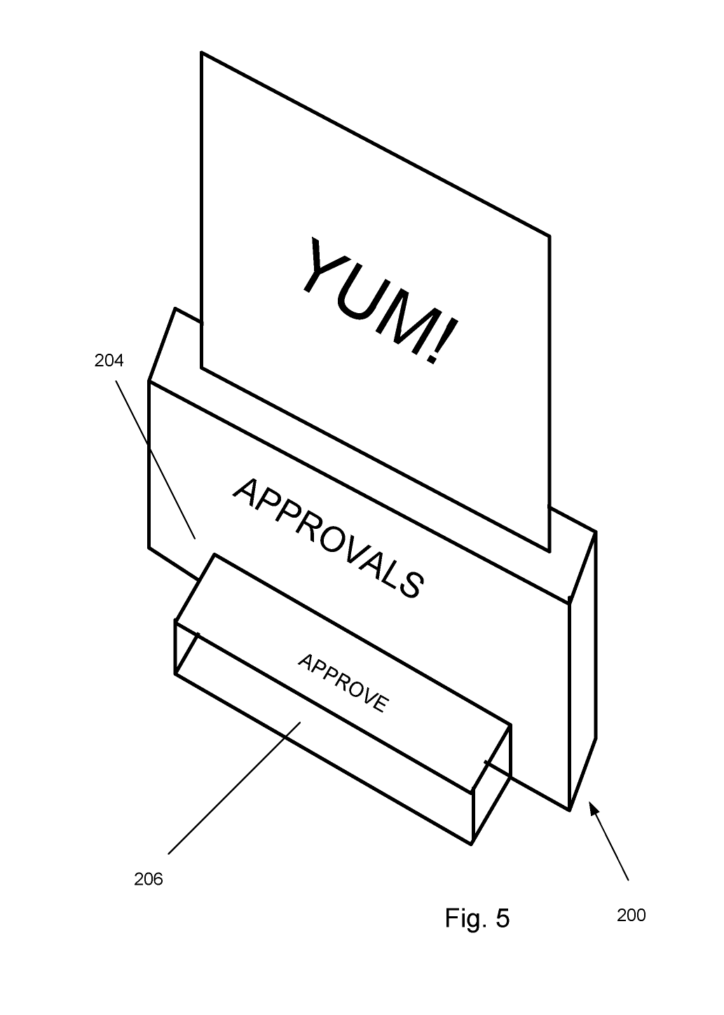

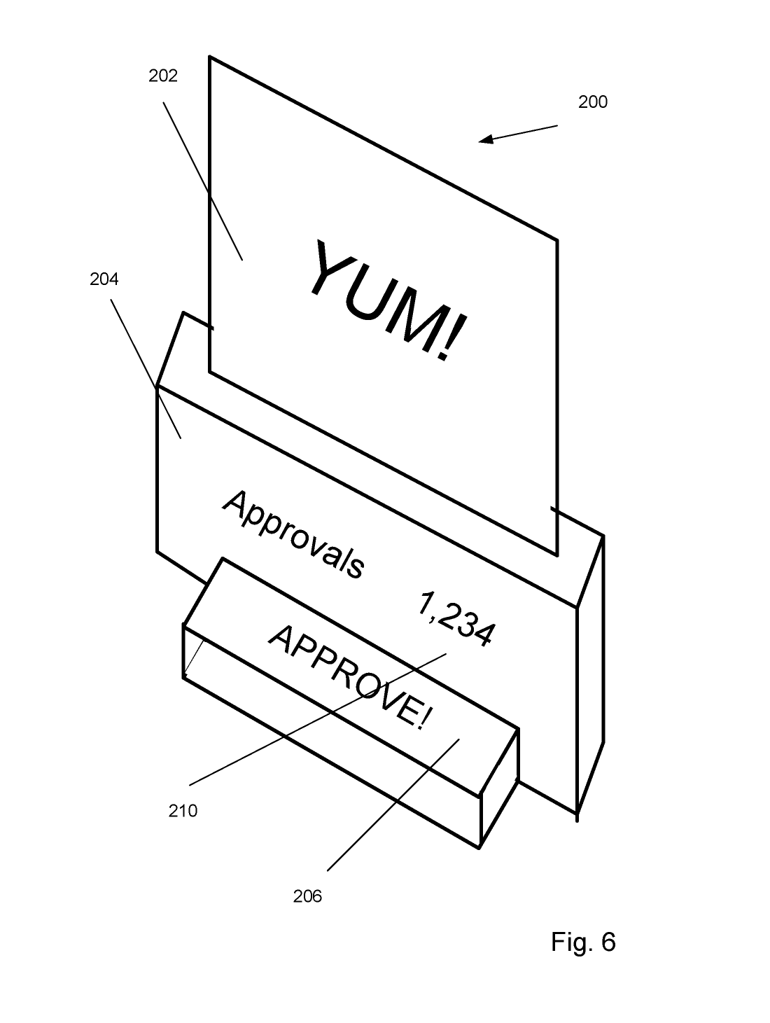

In other embodiments such as in FIGS. 5 and 6, the support 208 may take the form of a stand such as when the product is being displayed on a flat surface, such as a table. The support 208 may be made from any material that is sufficiently sturdy to support the product announcement 202 and enclosure 204. In some embodiments, the support 208 may have a connection to the display 200 in a manner that allows the display 200 to be connected in a supported manner or in a hanging manner. For example, the support 208 may have a slot (not shown) and the display 200 may have a corresponding protuberance from which the display 200 may be supported or hung in a secure manner. In addition, a screw or other securing device may be used to secure the display 200 from slipping out from the support 208.

In some embodiments, the support 208 may be multiple pieces. For example, a first support piece 208A may hold the announcement 202 and second support piece 208B may connect to a surface. The surface to be connected to may be vertical, horizontal or a variety of angles and shapes and the support piece may be adapted to effectively support the announcement 202. By having the support 208 be more than one piece, additional surfaces may be used for attachment and additional orientations may be obtained.

Connection Manner

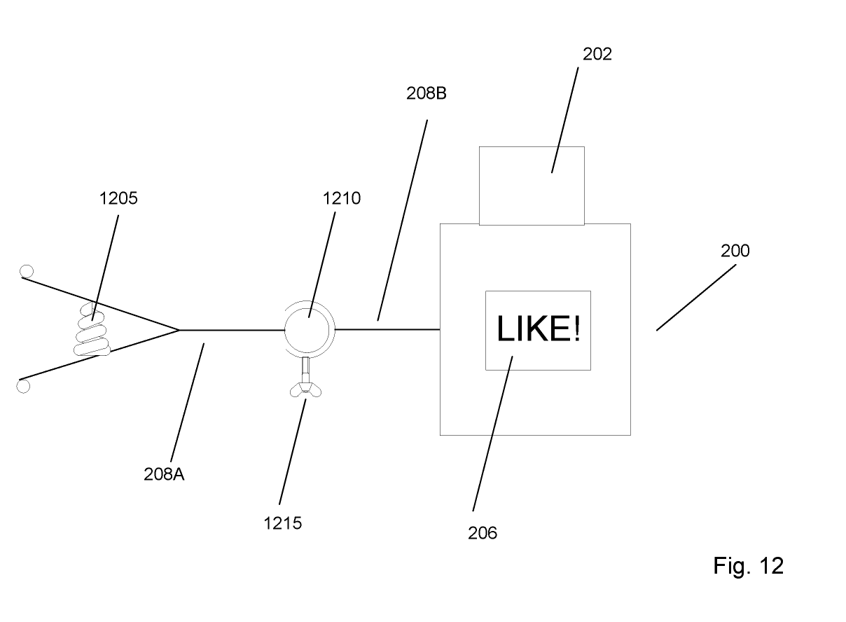

Referring briefly to FIG. 12, the first support piece 208A and the second support piece 208B may be connected in a variety of ways to ensure that the display 200 may operate in a variety of orientations, environments and situations. As on example, the first support piece 208A may have suction cups that attach to a surface such as glass on a refrigerated door. In yet another embodiment, the first support piece may be a spring loaded clamp 1205 that attaches to a variety of surfaces. In yet another embodiment, the first support piece 208A may be adapted to be in secure communication with the shelves in a grocery store which may have ridges, folds and contours which may be adapted to be in communication with the first support piece 208A. In addition, store shelves may have holes which may be used to bolt the first support piece 208A to the shelf in a secure manner. Further, a clamp like arrangement with a screw which may be thumb tightenable may be used to secure the first support piece 208A to the shelf.

In some embodiments. the orientation of the first support piece 208A and the second support piece 208B can be adjusted such that the announcement may remain vertical is a desire state. In one embodiment, the first support piece 208A and second support piece 208B are connected by a knuckle type connector 1210 and the knuckle connector 1210 may be tightened by using a screw 1215. In yet another embodiment (not shown), the first support piece 208A may be connected to a first disk and the second support piece 20813 may be connected to a second disk where the first and second disk may be tightened such that the any orientation between the first and second disk may be obtained. In addition, the disks may pivot in relation to the first support piece and second support piece which may add further orientation options. Of course, the connection may be created in a variety of ways, all of which are contemplated as being part of the display 200.

A power source 155 (FIG. 10) may be included in some embodiments of the display 200. The power source 155 may be needed to power the processor 150, the memory 165, the counter 210, a timer, etc. In some embodiments, the power source 155 may be a battery that is stored inside the display 200. In other embodiments, the power is supplied from a remote power source such a remote transformer that may supply power to a variety of devices. In yet another embodiment, a solar cell which may be powered from overhead lighting may be used as the power source 155. In addition, there may be a group of solar cells may be used to power one or more displays 200. In addition, the solar cells may be in communication with a battery or one or more capacitors which may store the power and distribute the power in an even way.

The processor 150 may be in communication with the power source 155 and the memory 165. The processor 150 may be any appropriate processor 150 that can perform the desired tasks and operate on the available power without drawing too much power to drain the power source 155 prematurely. The processor 150 may be local to the display 200 or may be remote and may communicate signals back and forth to the display 200.

An input 206 may be in communication with the input/output circuit and operable by a user to indicate a user approval or rating. The input 206 may be virtually any shape. The input may be a button that draws user attention. In some embodiments, the input 206 may he a light beam that is broken as an input. In another embodiment, the input 206 may be a touch screen that registers contact. In yet another embodiment, the input 206 may be voice activated. As an example, a user may state “like” or “three stars” into a microphone 106 on the display 200. The sound may be analyzed to determine if “like,” a rating or another keyword was communicated. If the keyword was understood, a count or rating may be registered.

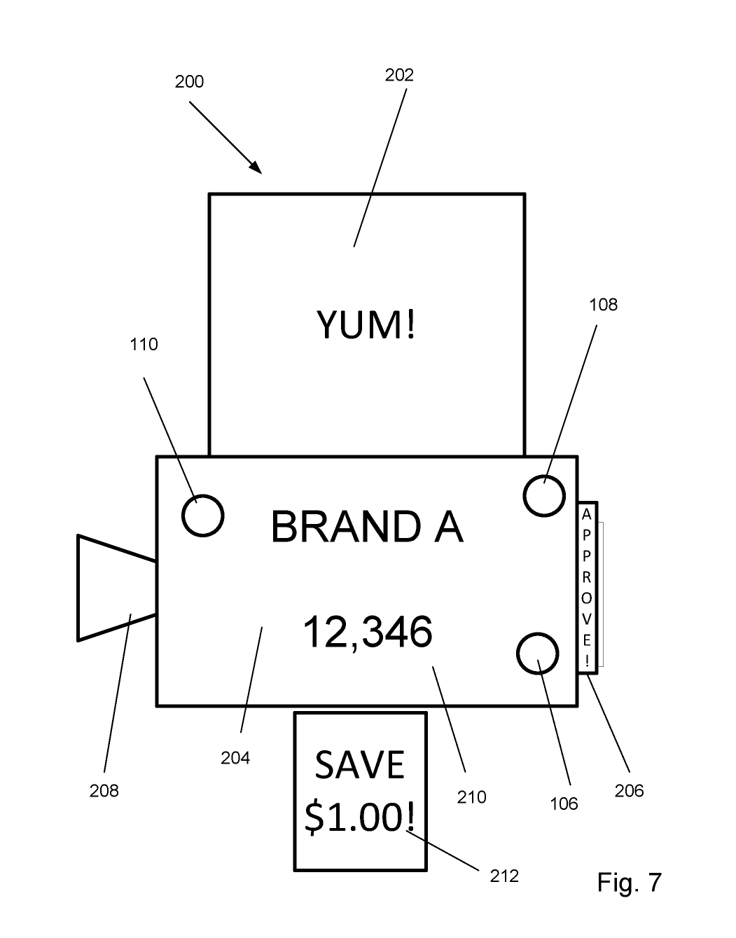

In yet another embodiment, the input 206 may be a motion of a user captured by an image capturing device. As an example and not limitation, a user may make a “thumbs up” gesture which may be captured by the image capturing device 108 (FIG. 7). Similarly, a user may hold up three fingers and a rating of three stars may be stored. The image may be analyzed and if the gesture is an acceptable gesture, a count or rating may be registered. In some embodiments, part of the display 200 may pivot allowing a user to register an input 206. An example, the input 206 may be a motion similar to pulling down a slot machine lever. In another embodiment, the display 200 may be shaped like a “thumbs up” and a handshake motion may register as the input 206. Of course, simple presses, clicks and the like are contemplated as inputs 206 also.

The input 206 may be a plurality of inputs and the inputs may create an approval indication such as in FIG. 3. The approval indication may take on a variety of forms and it may be based on the inputs received and the approval indication may be displayed in the counter 210. For example, the approval indication may be an accumulation of approval inputs received during a given period of time from one or more displays 200. The approval indication may also be based on a rating and the approval indication may be the average rating during a given period of time from one or more displays. In other embodiments, an algorithm may be used to determine the approval indication. As an example, the algorithm may weight more recent ratings higher than past ratings or ratings from similar stores may be given a greater weight than un-similar stores.

A plurality of inputs 206 may register a cumulative rating for the product. Thus, instead of just registering approval, the level of approval may be determined. For example as illustrated in FIG. 3, the input 206 may have four buttons and each button may represent a star rating, such as the first button representing a one star rating, a second button representing a two star rating. etc. In this embodiment, the input 206 may represent more than just an approval but also may represent the level of approval. In some other embodiments, a single button may be pressed repeatedly until the desired level of approval is obtained. In yet additional embodiment, the input 206 may be pressed and held until the desired rating rotates through the display 102.

If the input is a rating, the counter 210 of the display 200 may display the average rating for the product, the highest rating for the product or any other relevant data as desired. The rating may be for that day, that week, that month or any other time period. In addition, the display 200 may be in communication with other displays 200 such as through a central database that collects data from the displays 200. In such an environment, the rating may be a rating for a desired geographic area, for a specific type of store, or for any other manner of accumulating the data during any given time period. The rating to be displayed in the counter 210 may be selectable by the retailer.

Even if the input is a rating, an indication may be provided that the rating has been received. For example, if the current average rating displayed in the counter 210 is three stars and a three star rating is received, the display in the counter 210 may remain displaying three stars which may confuse a user as the rating displayed in the counter 210 may not change. The counter 210 may display an illustration or animation that the input 206 was received such that the user may receive affirmation that the input 206 was received.

In yet another embodiment, the counter 210 may display inputs received from a plurality of electronic sources. For example, a user may be at home and may input an approval for a product using a home computer. The input may be communicated to the central database and the counter 210 on the display may indicate the additional input from the user at home.

Logically, a user may use a portable computing device 101 in communication with the display 200 to enter the level of approval. The level may be a numerical entry or may be text that may be received, may be reviewed and may be displayed on the counter 210 of the display 200. Further, the user may be able to use an application on the portable computing device 101 to obtaining additional information of the level of approval from other users. By using a portable computing device 101, even more detailed reviews may be obtained.

The processor 150 may also execute a timing operation. The timing operation may ensure that a user cannot repeatedly select the input 206 in rapid succession. As the input 206 is supposed to indicate likes or ratings from individual users, the timer may ensure that a single user cannot register numerous inputs to the input 206. For example, a child may find it amusing to repeatedly press the input 206 and see the counter 210 increase. As a result of the timer, only one “like” input 206 may be accepted. In another embodiment such as when an image sensor 108 is part of the display 200, the images captured by the image device may be reviewed to ensure the input is from a distinct user, and if the user is distinct, the input may be counted as a like. If the input action is not from a distinct user, the input action may not be an acceptable input and the actuation of the input 206 may not be counted. If the user is using a portable computing device 101 as the input 206, the device 200 may recognize only one input from each device 101 during a given period of time.

The cumulative counter 210 may be in communication with the processor 150 and may track the number of acceptable inputs 206. The counter 210 may display the acceptable number of inputs 206 during a given time period. The number may be stored locally or may be stored remotely. In some embodiments, the number is stored locally and is collected periodically to be reported to a central server 141 for tracking purposes. In other embodiments, the number may be promptly communicated to a remote computing device 141. In some embodiments, there may a first counter 210 that tracks a first count, such as inputs 206 during a first period and a second counter 210 that tracks a second count such as of inputs 206 during a second period where the first period and second period are different periods of time. As an example, a first counter 210 may keep track of inputs 206 during a single day and the second counter 210 may keep track of inputs 206 for a week. In yet another embodiment, the first counter 210 may track inputs 206 at a first location and the second counter 210 may track inputs 206 over a wider geographical area such as in a state, a country, a county, etc. Of course, there may be additional counters 210 which may represent additional time periods, different geographical areas, etc.

As was previously described, the display 200 may accept not just approvals but also ratings. The device 200 may have the ability to accept a variety of ratings, such as 4 stars, 10 out of 10, etc. In some embodiments, a user make be able, to select a button that represents a rating such as 4 stars or a different button for 3 stars. In other embodiments, the user may press the input a number of times to rotate through the possible ratings. The ratings may be displayed in the counter 210. The ratings may be averaged over a desired period of time or the counter 210 may display the highest rating received during a period of time. As may be understood, the display of ratings in the counter 210 may be varied as desired by the retailer, the display 200 provider or the product provider as will be further described.

The product announcement 202 may take on a variety of eye catching forms. The product announcement may relate to a product or brand to which the announcement relates. As shelves may be crowded, the product announcement may be used to draw attention to a product or brand and to ensure that a user knows that an input 206 to the display 200 is related to a specific product or brand. In some embodiments, the product announcement 202 is a replaceable printed display, such as the logo for a product. In some embodiments, the perimeter of the product announcement 202 may be held in a frame. The frame may have sensors that enable a user to touch the announcement and have the product announcement 202 act as a touch sensitive surface, including acting as the input 206.

In other embodiments, the product announcement 202 may be a computer controlled display such as a led display device or an LCD display device. If the product announcement 202 is an electronic display device, it also may be touch sensitive and act as the input 206. In some embodiments, the entire display 202 may act as the input 206 and in other embodiments, a section of the display 202 may be indicated as the input 206.

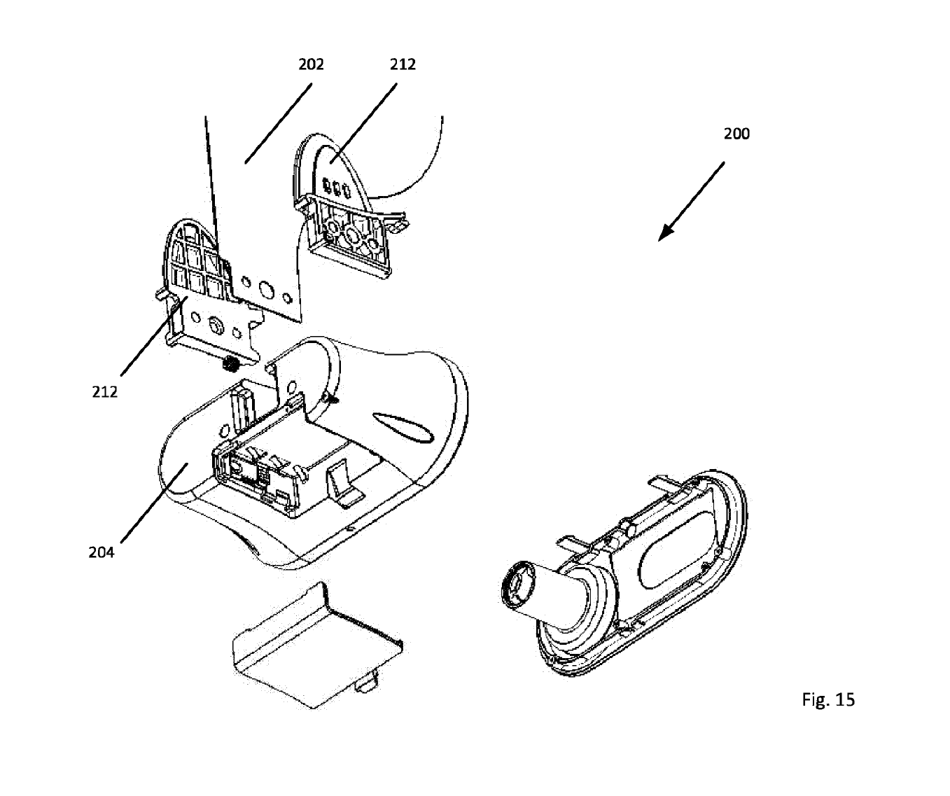

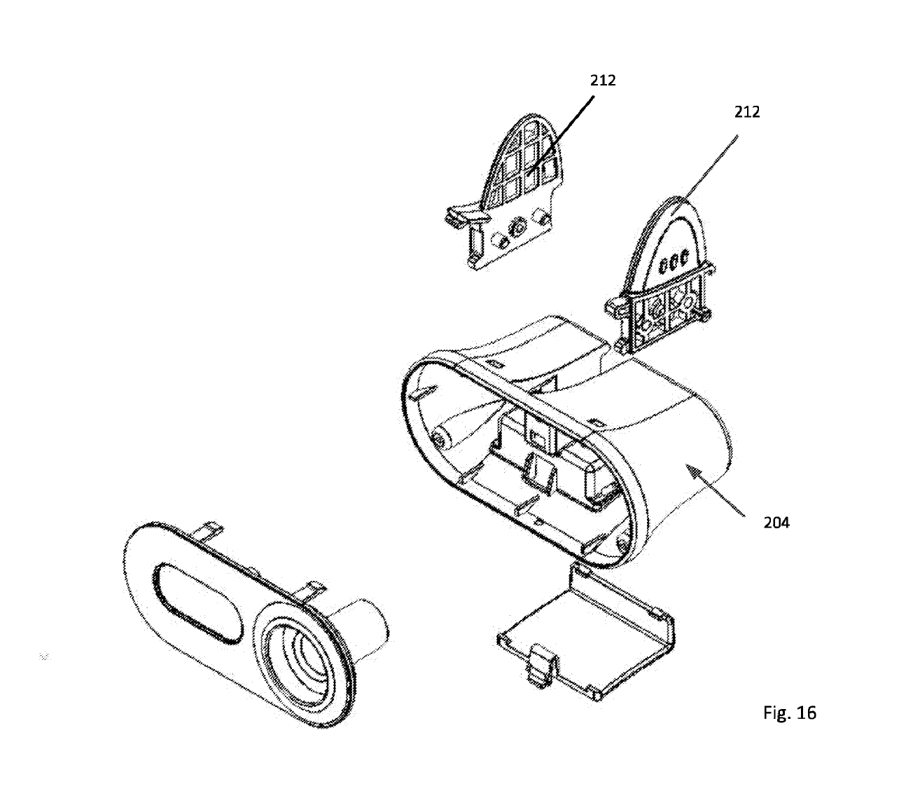

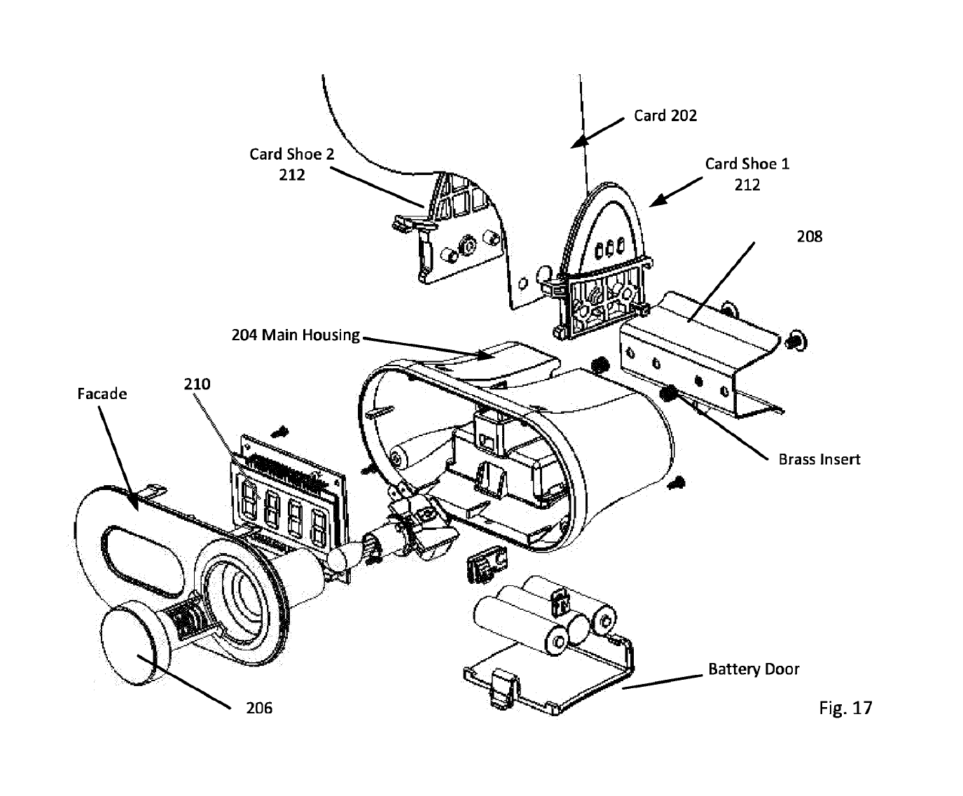

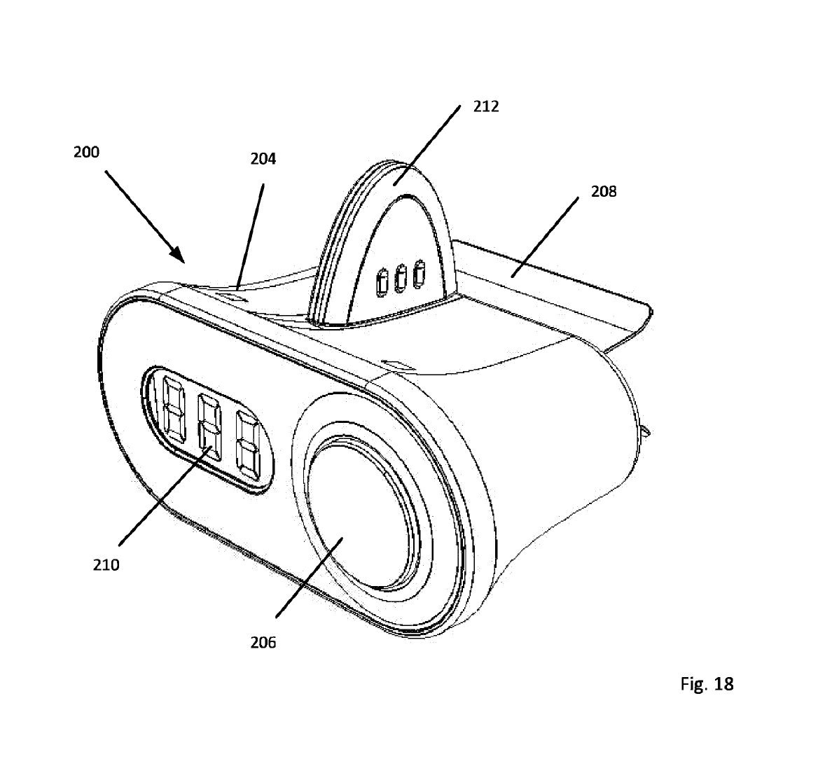

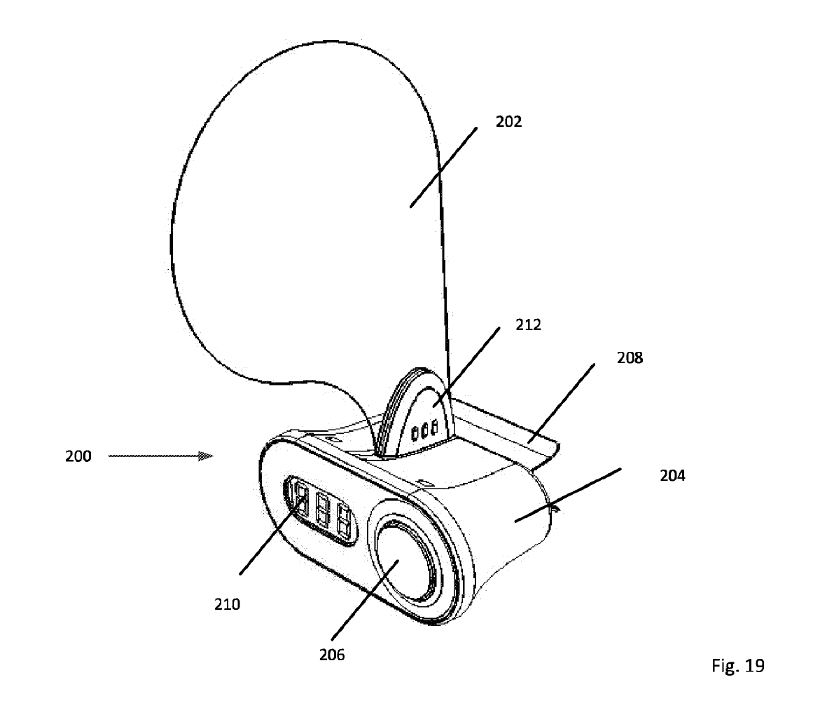

In some embodiments, the product announcement may be in communication with a base or portion 212 that may also be in communication with the display 200. As illustrated in FIGS. 15, 16, 17, 18 and 19, the base may be made of two parts that are in communication with the display 200 and may securely but release-ably hold the product announcement 202. As an example the base 212 may be opened, a first product announcement 202 may be removed, a new product announcement 202 may be added and the base 212 closed again.

Another feature of the display 200 may be a digital image sensor 108 (FIG. 7) such as a camera or a scanner in communication with the processor 150. Digital image sensors 108 are commonly available and the computer executable instructions for the image sensor 108 may be local or remote. The image sensor 108 may have a variety of uses and purposes.

In one use, the digital image sensor 108 may provide images which are analyzed to ensure each input is from a unique individual. For example, a child in a red coat may repeatedly touch the input 206. Only one touch to the input 206 may be counted as an acceptable input as the inputs may need to be from distinct people. If the images confirm that the touches to the input 206 are from one person, only one may be counted. On the other hand, if the analysis concludes a variety of users have touched the input 206, each of the touches may be counted as acceptable inputs.

Acceptable inputs may be indicated in a variety of ways such as making a pleasing sound through a speaker 110 in communication with the processor 150, such as announcing “LIKE!” or “Right on!” in a memorable manner, updating the counter 210, having the product announcement 202 flash, sequence through a series of displays, dance, sparkle or display a pleasing graphic. Similarly, unacceptable inputs may result in unpleasant sounds, buzzers, announcing “BONG!”, having the product announcement 202 display an unwanted graphic or simply go dark. In some embodiments, the microphone 108 may be used to record users speaking “LIKE!” or “Four stars!”. In some embodiments, all inputs, whether they are touches to the input 206, recorded voice messages, recorded video messages, or other inputs may be stored in a memory 165 along with a time stamp, a date stamp and/or a location stamp.

In yet another embodiment, the display 200 may have a light beam and a light sensor and if a user breaks the light beam such as with a hand swipe or a foot swipe, an input may be registered. In yet another additional embodiment, the light beam may project the number of acceptable inputs or ratings on a surface, such as on the floor, making the display 200 even more attractive and useful. The light may flicker, dance, change colors, display words or images or any other image that may draw attention to the display 200.

In some embodiments, the display 200 may also have a microphone 106 that may be in communication with the processor. The microphone 106 may have several uses. In some embodiments, it may sense noise and the noise may result in the display 200 entering an awake state where the product announcement 202 is operating, the input 206 is ready to receive input actions and the counter 210 is displayed. Similarly, the microphone 106 may sense a lack of sound for a given period and may place the display 200 into a sleep state to conserve power. As previously noted, the microphone 106 may also accept commands for the display 200 such as accepting “LIKE” as an input 206, “RESET” or another code word to reset the counter 210 or using voice print technology to attempt to identify a user based on the user's voice as will be further explained. A user may also have the option to record a message for the product manufacturer by making a selection on the product announcement 202 or on the display 200.

The image sensor 108 images may also be analyzed and used to notify users of the retail display functionality. For example, if no one is in the vision of the image sensor, then part of the processor that control the input 206 may be shut down to save energy. Similarly, if the product announcement 202 is electronic, the announcement 202 may be shut down or enter a “sleep state” until a user is in view of the image sensor 108 to conserve energy. When a user does enter the view of the image sensor 108, the display 200 may undertake a variety of actions to draw attention to itself (enter an “awake state”) such as making noise or an announcement through a speaker 110, flashing or brightening the product announcement 208 if the announcement 208 is electronic, spinning an uneven weight to make the product announcement 208 shake, etc. Of course, the manner of drawing attention to the display 200 are numerous and varied and may be limited only by imagination.

In another aspect, the image sensor 108 images are analyzed to determine if a code is present. The code could be a bar code, a three dimensional code, a QR code, a UPC code or other relevant code that contains information. If a code is present, it may be determined if the code requires action by the device. For example, one code may be known by an authority and may reset the counter 210. In another example, the code may be for a product and a video related to the product and may be displayed on an electronic product announcement 202. A simple example may be that the sale price for the item is displayed on the product announcement for the specific user. Further, the images may be used to attempt to identify user actions such as a like action or a reset action or to identify specific users as will be explained. A user may also have the option to record a video message for the product manufacturer by making a selection on the product announcement 202 or on the display 200.

In yet another aspect, the image sensor 108 may assist the retailer and product supplier. The image sensor 108 may be used to view currently inventory of shelves and whether the inventory is displayed in a neat and desirable manner. If the shelves are empty of a product, the retailer and the product supplier may be notified of the supply issue. Similarly, if a similar product is sold out but the product in question is not selling, a notice may be communicated that the product should be reviewed. Finally, the retailer may utilize the image sensor 108 for crime prevention purposes by watching for theft and the like.

In another embodiment, the display 200 may not be specifically set up for a single product but may be able to serve a variety of products. The image sensor may determine the product of interest to the user and may display information on the product announcement 208 related to the product of interest. For example, the image sensor 108 may scan a product UPC system and display information related to the product on the product announcement 202. The information may be static, may be active or even interactive. The display information may be stored locally or remotely and may be accessed through the input/output circuit 175 which may communicate with remote servers through wired or wireless communication devices.

The display 200 may also offer coupons to users. In some embodiments, the coupons are traditional paper coupons and in other embodiments, the coupons are communicated wirelessly. Further, the coupons may be offered in response to the user using the input button to input an acceptable input 206. In other embodiments, the display 200 may also display a price 1305 (FIG. 13) for an item. In some embodiments, the prices 1305 displayed on the device 200 may be adjustable. The adjustment may happen in the store or may be accomplished through a network connection. The adjustment may be dynamic, such as if sales are high for an item, the price 1305 may be raised and if demand is low, the price 1305 may be lowered. Similarly, if the potential buyer is recognized either through a sensor, a card, or other manners of identification, an individual price 1305 for the buyer may be determined, displayed and stored for use at checkout, enabling instantaneous marketing of pricing for specific, recognized individuals.

The display 200 may also gather identification information from a user with permission from the user. The identification information may be gathered in a variety of ways. In one embodiment, an id card for the user may be scanned by the image sensor 108. In another embodiment, wireless identification may be used such as by matching portable computing device wireless information with known information about a user. For example, a user may have a portable computing device 101 such as a smart phone with Bluetooth, Wi-Fi, or low power Bluetooth (such as iBeacon with Bluetooth low energy proximity sensing to transmit a universally unique identifier) and cellular signals and the MAC address for the smart phone may be communicated to the display 200 where the MAC address or other universally unique identifier is matched to a user. Of course, near field communications (NFC) may also be used to identify a portable computing device 101. Similarly, a smart credit or debit card with a capacitance chip may be used by the display 200 to provide information about the user.

Related, voice analysis from the microphone 106 may be used to match user voices to known voice prints of users. Similarly, the image sensor 108 may be used to attempt to identify users using facial analysis algorithms. In some advanced embodiments, the image sensor and/or touch sensors may be used to obtain a user's fingerprints for user identification purposes. In even more advanced systems, retina scans of users may be obtained. Of course, a combination of voice analysis, image analysis and other gathered data may be used together to determine the user. The identification data may be fed to a local or remote database 325 where the identification data may be quickly compared to known data to determine a user.

Once a user is identified, whether the user inputted a “like” or rating may also be stored. The database may have a variety of information such as information from past purchases, buying habits, likes and responses to previous offers. If the user is known, and if the user is known, the user likes may be analyzed to determine further actions with respect to the user. Some users may not be swayed in their purchasing decisions unless an offer is very aggressive. Other users may be swayed by less aggressive offers. As previously mentioned, by analyzing the information on the specific user, individual pricing 1305 and incentives may be created.

In some embodiments, the user may be able to communicate the user input “approvals,” ratings or other audio or visual inputs to other outside services such as Facebook®, Google Plus™, Twitter, blogs, emails, RSS feeds, etc. The communication preferences may be set up in advance or may be set up at the display 200 using the product announcement 202 or counter 210 with a touch sensor as a keyboard for input data. In yet another embodiment, voice recognition software may allow a user to speak the necessary information to set up the outside communication preferences.

In additional embodiments, a wireless communication device may be in communication with a portable computing device 101 of a user. The portable computing device 101 may be used to communicate the approval input to device 200. For an example, a user may obtain an application or connect to a network site that operates on the portable computing device 101 and the application may communicate with a wireless communication device in the retail environment. The user may then be able to user the portable computing to operate 101 the functions of the device 200. In addition, the portable computing device 101 may have more functionality. For example, the user may be able to add specific comments on a product. The comments may be communicated to a database and the comments may be further disseminated such as to a network or web site for the product.

Further, the device 200 may communicate to a portable computing device 101 of the user. If the user gives permission, the user may select to receive data from the device 200. The data may offer additional information about the product such as nutritional information or uses for the product. Similarly, the device 200 may offer multi-media presentations about the product. Further, the device 200 may offer interactive information about the product or may connect a user to a web site that is dedicated to the product. Further, the user may be able to download an application dedicated to the product. Also, the user may have the option to register with the product supplier and receive even more information about the product.

The counter 210 may continue to increase for a given period of time which may be adjustable or until the counter 210 is reset. The reset may occur in a variety of ways. In some situations, a reset button may be pressed which is concealed on the display. In other embodiments, a reset code may be keyed into the input 206 such as three long pushes followed by three short pushes. A reset code may be announced which may be parsed by the voice recognition software and the reset action may be executed. A reset code also may be received from a remote computing device 141, from the image sensor 108 or from a portable computing device 101. In yet another embodiment, the display 200 may be reset when the announcement 202 is removed. For example, a switch may be open when the announcement 202 is in place and the switch may close when the announcement 202 is removed which may reset the display 200.

The display 200 also may have a motion sensor and an alarm which may execute if the display 200 is removed without permission. Examples of the display alarm may be a screeching sound, a flashing light, a wired or wireless signal to an authority or the device may simply shut down permanently. Further, the display 200 may zero out the counter 210 and may clear any stored data, ensure that the data not be obtained by undesirable people. In addition, the motion sensor may be used to allow the display 200 to enter a low power or sleep mode when no motion is sensed and to enter a full power mode when motion is sensed. Logically, other sensors may be used to switch from an active mode to a sleep mode such as sound sensors, photo sensors, heat sensors, etc., as will be described further.

In other embodiments, an effort may be made to make the displays 200 tamper resistant. The display 200 may be locked to a surface using a locking type device and may only be removed with a key or code. Similarly, the display 200 may be attached using bolts or zip ties that cannot be removed without advanced tools not carried by most shoppers.

The display 200 also may provide feedback to the user in a variety of ways. In some embodiments, there may be lights designed to provide interest to the user. For example, the lights may attempt to create the illusion that the display 200 is communicate the input 206 is being wirelessly communicated such as the lights progressive lighting similar to lights on a wireless router as if the communication is leaving the display 200. Referring to FIG. 13d, the lights 1305 may progressively illuminate from bottom to top. The display 200 may even have a wireless antenna which may or may not be operative but may further enforce the illusion that the input 206 is being communicated. In another aspect, the sound an email being sent (“whoosh”) may be communicated when an input 206 is received.

In another embodiment, the display 200 may be modular, having parts that can be added or removed with ease depending on the installation. Referring to FIGS. 14a-14d, there may be a frame 1400 in which the different modules 1405 lock into place. In another embodiment, the modules 1405 may not need a frame 1400 but may lock into each other. As illustrated in FIGS. 14a-14d, the modules 1405 may be arranged in a variety of orders. In some embodiments, there may be two modules 1405 (FIGS. 14c and 14d) and in other embodiments, there may be three or more modules 1405 (FIGS. 14a and 14b). The modules 1405 may connect together in a variety of known secure manners such as twist-to-lock, snap fit, bolts, clips, etc. In such an embodiment, changes may be easily made to the display 200 without having to completely remove the display 200.

In other embodiments such as illustrated in FIGS. 15-17, the device may be made up of a variety of pieces that are secured together to form a single display 200. As may be seen, the device may be modular to make assembly easy and allow for maintenance and improvements over time. For example, some stores may not desire to have noise when an input is received and these stores may not have a speaker element installed while other stores may encourage noise and a speaker may he snapped into the circuitry in a modular fashion.

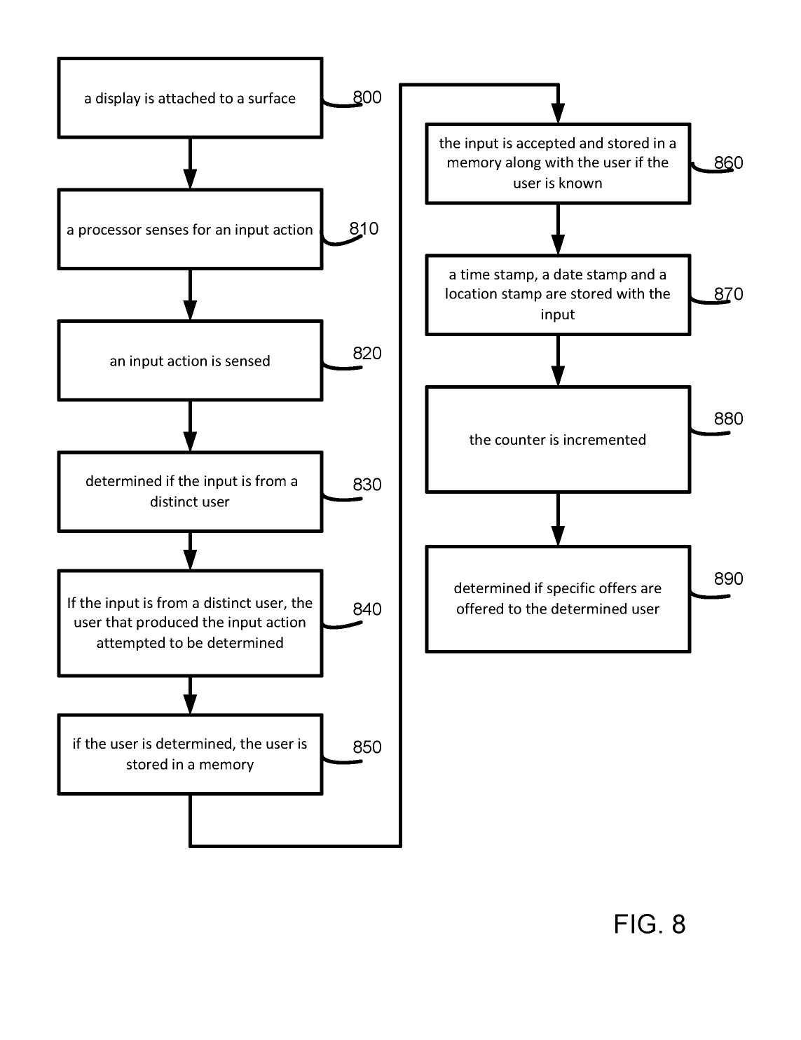

A method of accepting an approval is also disclosed in FIG. 8. At block 800, a display is attached to a surface. As mentioned previously, the surface may be vertical or horizontal or anywhere in between. At block 810, a processor 150 may sense for an input action. The input action may be a touch of an input 206, a voice command, an action or a combination of touch, voice and action. At block 820, an input action is sensed. At block 830, it may be determined if the input 206 is from a distinct user. If the input 206 is from a distinct user, at block 840 the user that produced the input action may attempt to be determined. At block 850, if the user is determined, the user may be stored in a memory 165. At block 860, the input 206 may be accepted and stored in a memory 165 along with the user if the user is known. At block 870, a time stamp, a date stamp and a location stamp may be stored with the input 206. At block 880, the counter 210 may be incremented. At block 890, it may be determined if specific offers may be offered to the determined user. Of course, additional blocks may be added and blocks may be removed without changing the described device.

The device 200 may also have a set up or configuration mode. This mode may allow the set-up of the device 200 for its intended purpose. The set up mode may be entered in a variety of ways. In one embodiment, the input 206 may be used in a specific sequence such as three long inputs, followed by three short inputs. In another embodiment, the configuration mode may be entered by scanning a code or image using the digital image scanner 108 from an authority. In yet another embodiment, a voice command to the microphone 106 may begin the configuration mode. In yet another embodiment, an additional computing device may be in communication with the device 200 and the additional computing device may accept an input from an authority such as a password to be sure the authority has rights to enter configuration mode.

Once in the configuration mode, the mode might allow the selection of specific device functions for a campaign. For example, a jingle may be loaded into the memory 165 for a first campaign and a second campaign may include loading specific visual cues. Further, certain functions may be required for some promotions but not others and the selection of the functions may be made during the configuration mode. Logically, the configuration may be accomplished locally such as with a hand held computing device 101 or remotely from a server 141, for example.

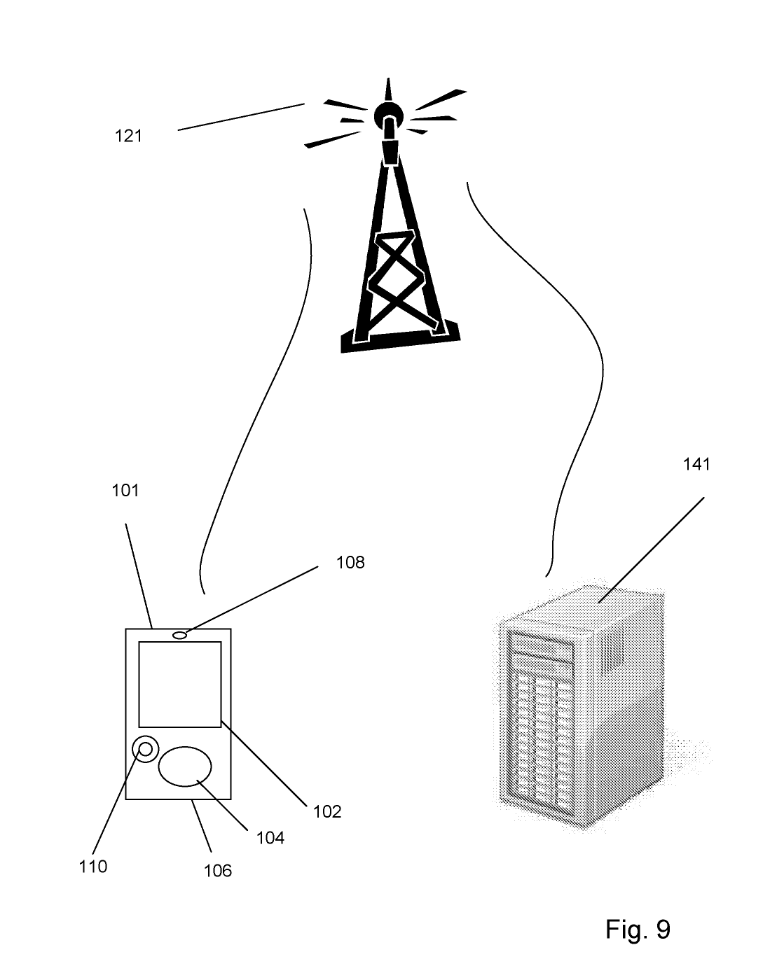

FIG. 9 may be a high level illustration of some of the elements a sample computing system. The computing system may be a dedicated computing device 141, a dedicated portable computing device 101, an application on the computing device 141, an application on the portable computing device 101 or a combination of all of these. FIG. 9 may be a high level illustration of a portable computing device 101 communicating with a remote computing device 141 but the application may be stored and accessed in a variety of ways. In addition, the application may be obtained in a variety of ways such as from an app store, from a web site, from a store WiFi system, etc. There may be various versions of the application to take advantage of the benefits of different computing devices, different languages and different API platforms.

In one embodiment, a portable computing device 101 may be a device that operates using a portable power source 155 such as a battery. The portable computing device 101 may also have a display 102 which may or may not be a touch sensitive display. More specifically, the display 102 may have a capacitance sensor, for example, that may be used to provide input data to the portable computing device 101. In other embodiments, an input pad 104 such as arrows, scroll wheels, keyboards, etc., may be used to provide inputs to the portable computing device 101. In addition, the portable computing device 101 may have a microphone 106 which may accept and store verbal data, a camera 108 to accept images and a speaker 110 to communicate sounds.

The portable computing device 101 may be able to communicate with a computing device 141 or a plurality of computing devices 141 that make up a cloud of computing devices 111. The portable computing device 101 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 141 or may be through a communication network 121 such as cellular service, through the Internet, through a private network, through Bluetooth, etc. FIG. 10 may be a simplified illustration of the physical elements that make up a portable computing device 101 and FIG. 11 may be a simplified illustration of the physical elements that make up a server type computing device 141.

FIG. 10 may be a sample portable computing device 101 that is physically configured according to be part of the system. The portable computing device 101 may have a processor 150 that is physically configured according to computer executable instructions. It may have a portable power supply 155 such as a battery which may be rechargeable. It may also have a sound and video module 160 which assists in displaying video and sound and may turn off when not in use to conserve power and battery life. The portable computing device 101 may also have volatile memory 165 and non-volatile memory 170. There also may be an input/output bus 175 that shuttles data to and from the various user input devices such as the microphone 106, the camera 108 and other inputs 102, etc. It also may control communicating with the networks, either through wireless or wired devices. Of course, this is just one embodiment of the portable computing device 101 and the number and types of portable computing devices 101 is limited only by the imagination.

The portable computing device 101 may act as the display 200 or may be a part of the display 200. In addition, a first portable computing device 101 may be part of the display 200 and a second portable computing device 101 may be a smart phone of a user which may communicate with the display 200. Further, a third portable computing device 101 such as a configuration portable computing device 101 may be used by a retailer or supplier to interact with the display 200.

The physical elements that make up the remote computing device 141 may be further illustrated in FIG. 11. At a high level, the computing device 141 may include a digital storage such as a magnetic disk, an optical disk, flash storage, non-volatile storage, etc. Structured data may be stored in the digital storage such as in a database. The server 141 may have a processor 300 that is physically configured according to computer executable instructions. It may also have a sound and video module 305 which assists in displaying video and sound and may turn off when not in use to conserve power and battery life. The server 141 may also have volatile memory 310 and non-volatile memory 315.

The database 325 may be stored in the memory 310 or 315 or may be separate. The database 325 may also be part of a cloud of computing device 141 and may be stored in a distributed manner across a plurality of computing devices 141. There also may be an input/output bus 320 that shuttles data to and from the various user input devices such as the microphone 106, the camera 108, the inputs 102, etc. The input/output bus 320 also may control of communicating with the networks, either through wireless or wired devices. In some embodiments, the application may be on the local computing device 101 and in other embodiments, the application may be remote 141. Of course, this is just one embodiment of the server 141 and the number and types of portable computing devices 141 is limited only by the imagination.

As mentioned previously, the display 200 or displays 200 may be in communication with a central computing device 141 or devices 141. At a high level, the computing device 141 may be configured to allow the devices to be monitored, maintained and updated. The central computing device 141 may also provide an ability to review and adjust a variety of features and options on the display 200 As an example, a display 200 may have a technical problem. The computing device 141 may be configured to allowed the display 200 to be reset. Similarly, the computing device may communicate that the display 200 should be turned off during hours when the store is closed to conserve energy. Similarly, the status of the battery may be viewed remotely and if the battery needs to be replaced, a message may be automatically generated to a service technician that the device 200 needs service. In yet another example, an update may be communicated to the display 200 and that update may be product specific such as a displaying a specific logo, displaying a new price or playing a specific jingle.

In addition, a retailor may be able to adjust the display remotely through communication on a central application. For example, if the device 200 is not receiving much use, there may not be many approvals displayed on the counter 210. In these situations, it may be beneficial to display all the approvals from a geographic area on the counter 210 rather than a single store. Similarly, the approvals may include ratings and the ratings may be displayed in a way to make the product appear more desirable. The retailer may also see if a product location results in more approvals or stronger approvals.

The data from the displays 200 may also be captured and stored for further analysis for a variety of purposes. As an example, the data may indicate users select to approve a product when it is priced below a threshold but may indicate that users do not select to approve a product when it is priced above a threshold. As another example, a product such as a snow shovel may be “approved” more when it is sold in an area with snow and may be “approved” less when it is sold in an area without snow. As yet another example, the data may be analyzed to determine how much interest there is a product and if the interest changes based on changes in price, packaging, advertising, etc. The data may be reviewed to determine if there is a difference in approval based on time, location, prices, etc. A variety of applications may be created to analyzed the data and display the data in raw form or in analyzed form in a plurality of formats to a plurality of users, all with different goals.

Also, a dashboard application may be created that quickly indicates the approval status of one or more products. The dashboard may also compare approval status for a current store as opposed to stores in general. Similarly, the dashboard may related sales in stores with the display 200 to sales in stores without the display 200. Of course, with a selection, the raw data behind the illustration may be viewed, reviewed and further analyzed.

In addition, as previously mentioned, in some embodiments, a specific shopper may be identified. With permission of the user, the data from the display 200 may be tied to the specific user. Further, outside data sources such as credit bureaus may be consulted to provide additional data about the user. The user data may be studied for specific individuals or may be studied in aggregated form as the data of customers with similar desired traits may be studied together. As more information about the users is obtained, the response to the display 200 and the related shopping habits may become even more useful.

In some embodiments, the camera 108 and microphone 106 may be part of the display 200 or as part of a portable computing device 101 may be used to observe shoppers in a retail environment. In one aspect, users may be observed to ensure shoplifting or other undesired behavior is not occurring. In another aspect, users may be directly observed while they move through a store. As a result, reactions of users such as verbal approvals, smiles, groans, reaching to review items, etc. may be observed. As a result, users responses to changes may be directly observed. As already mentioned, the data may be reviewed and analyzed in a variety of ways.

The central computer 141 may be physically configured to allow one or more users to review the data from the display 200. The provider of the display 200 may monitor the data to ensure that the device 200 is operating properly. The retail environment may use the data to determine if the display 200 is generating additional interest in the specific product in the store, whether the price is affecting interest, whether packaging is affecting interest, etc. The product manufacturer may also view the results and compare the results across time, geography, by local income, etc. The data may be used by a variety of users for variety of purposes.

Logically, the data on the central computing device 141 may be accessible by a variety of computing devices such as a portable computing device 101. The portable computing device 101 may communicate with the central computing device 141 and the data from the display 200 may be reviewed and analyzed from virtually any location.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A display comprising:
A support for supporting a display device adjacent with a surface;
The display device comprising:
A product announcement portion for displaying a product announcement;
A power source;
A processor in communication with the power source;
An input/output circuit;
An input in communication with the input/output circuit and operable by a user to indicate a user approval;
An approval display portion; and
A timing circuit that controls the number of inputs that are received in a given period of time as acceptable inputs.

2. The display of claim 1, further comprising:
a counter that communicates data regarding the acceptable inputs to a remote computing device.

3. The display of claim 1, wherein the product announcement is a replaceable printed display.

4. The display of claim 1, wherein the product announcement is a processor controlled display.

5. The display of claim 1, further comprising a digital image sensor in communication with the processor.

6. The display of claim 5, wherein the images from the digital image sensor are analyzed to ensure each input is from a unique individual.

7. The display of claim 1, further comprising an audio speaker.

8. The display of claim 1, wherein there is one or more central processors is configured to communicate with a plurality of displays.

9. The display of claim 1, wherein information is gathered from the user using a portable computing device with identification information and at least one selected from a group consisting of:
near field communication,
Bluetooth communication,
Cellular communication;
Wifi communication;
Image analysis from an image sensor;
Fingerprint analysis from the image sensor;
Retina analysis from the image sensor; and
Voice analysis from a voice recorder.

10. The display of claim 1, further comprising a microphone in communication with the processor.

11. The display of claim 1, further comprising a motion sensor.

12. The display of claim 1, wherein the input is acknowledged with a sensory response and wherein the sensory response comprises a sound, a movement or a visual indication.

13. The display of claim herein the input is a rating.

14. The display of claim 1, wherein the acceptable inputs are communicated to a separate computing device.

15. A system for attracting attention of a consumer to a product using an interactive display device comprising the steps of:
1) Mounting the display device adjacent a product being promoted;
2) Arranging product information on the display device so as to be visible to the consumer;
3) Including in the display device an input of an input/output circuit which may be activated by said consumer to indicate approval for the product;
4) Recording an activation of said input by said consumer in said input/output circuit;
5) Accumulating the consumer input from the input/output circuit; and
6) Displaying an approval indication based on the accumulated consumer input from the input/output circuit.
